(19) United States
(12) Patent Application Publication
(10) Pub. No.: US 2005/0279536 A1
(43) Pub. Date: Dec. 22, 2005

(54) Axle kit

(75) Inventor: Chris A. Iverson, Dayton, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Performance Engineering & Machine, Inc., Rogers, MN (US)

(21) Appl. No.: 10/873,678

(22) Filed: Jun. 22, 2004

(51) Int. Cl. B62D 11/02

(52) U.S. Cl. 180/9.1; 180/190

(57) ABSTRACT

The present invention is an axle kit for a tracked vehicle. The tracked vehicle contains an endless track of a specified length, a suspension system, and two generally parallel rails attached to the suspension system containing a plurality of idler wheels attached to the parallel rails. The axle kit allows for replacement of the existing idler wheels with larger diameter idler wheels without a change of the specified length of the endless track. The axle kit comprises a first attachment member, a second attachment member and a main body. The main body comprises a first connection member, a second connection member, and a single machined cylindrical axle connected to the first and second connection members.

### CROSS-REFERENCE TO RELATED APPLICATION(S)

NONE

### BACKGROUND OF THE INVENTION

This invention relates to an offset axle for idler wheels of a tracked vehicle. Particularly, the invention is an improvement for offset axles for a snowmobile capable of improving the performance of the vehicle.

Tracked vehicles, specifically snowmobiles, are used in snowy regions. Such vehicles are used not only as means of transportation, but are also popular for recreational purposes including trail riding and racing. Differing snow conditions on the ground and the riding terrain affect the snowmobile's performance. On icy or hard-packed snow, a track vehicle uses a shorter track for a better performance. Short track vehicles are commonly used for trail riding. In contrast, in deep new fallen snow, which results in less packed snow conditions, a long track is desired for better performance. The length of the track is the distance over which a track contacts the surface on which the tracked vehicle is driven. Traction between the tracked vehicle and the ground determines the length of the track of the vehicle.

Tracked vehicles contain rear suspensions generally consisting of front and rear suspension arms pivotably mounted on shafts, which are rotatably connected to a frame. The frame comprises a pair of spaced side rails transversely interconnected on opposing lateral sides of the tracked vehicle. Side rails are in contact with an endless track which contacts the snow surface and drives the vehicle. Typically, the back of the side rails contain an axle spanning between side rails and contains two or more idling wheels.

Typically, tracked vehicles contain rear idler wheels set about an axle that is mounted between the rear rails. The axle is mounted such that the outer mounting blocks are in alignment with the center of the axle. A plurality of idler wheels of a particular size are then mounted to this axle. In order to improve performance and speed of the snowmobile, it is preferable to have a larger back idling wheel. The back idler wheel must be sized such that it does not interfere with running the track underneath the chassis. Further, increasing the size of the idler wheels about the existing axle may necessitate an increase the length of the track of the snowmobile. What is needed in the art is a way to complete installation of increased diameter idler wheels without modification to the rails or the track of the snowmobile.

### BRIEF SUMMARY OF THE INVENTION

The present invention is an offset axle for idler wheels of a tracked vehicle. Typically, idler wheels of a tracked vehicle are the rearmost set of wheels contained within the track which are a component of the suspension and drive system. The offset axle of the present invention allows for the installation of larger diameter idler wheels, which enhance the performance of a vehicle.

The offset axle of the present invention is made to mount to the preexisting rails of a tracked vehicle. In one embodiment, the central shaft is offset from the connecting members via a bridged portion. In a second embodiment, wheel mounts for offset idler wheels engaging the outer edges of the track are connected to the attachment portion of the offset axle. In yet another embodiment, the offset axle contains both offset wheel mounts and an offset shaft. All three embodiments allow for the installation of a larger diameter idler wheel without necessitating a change in the length of the track used on the vehicle.

### BRIEF DESCRIPTION OF THE DRAWINGS

FIG. 1 is a rear perspective view of an axle assembly containing an offset axle shaft of present invention.

FIG. 2 is a rear perspective view of an axle assembly having offset idler wheel mounts according to the present invention.

FIG. 3 is an exploded rear perspective view of the axle assembly of the present invention.

FIG. 4. is a side view of the rear of a tracked vehicle showing an idler wheel mounted on the present inventive axle.

The present invention is explained with reference to the drawing figures, wherein like structures are referred to by like number throughout the several views.

### DETAILED DESCRIPTION

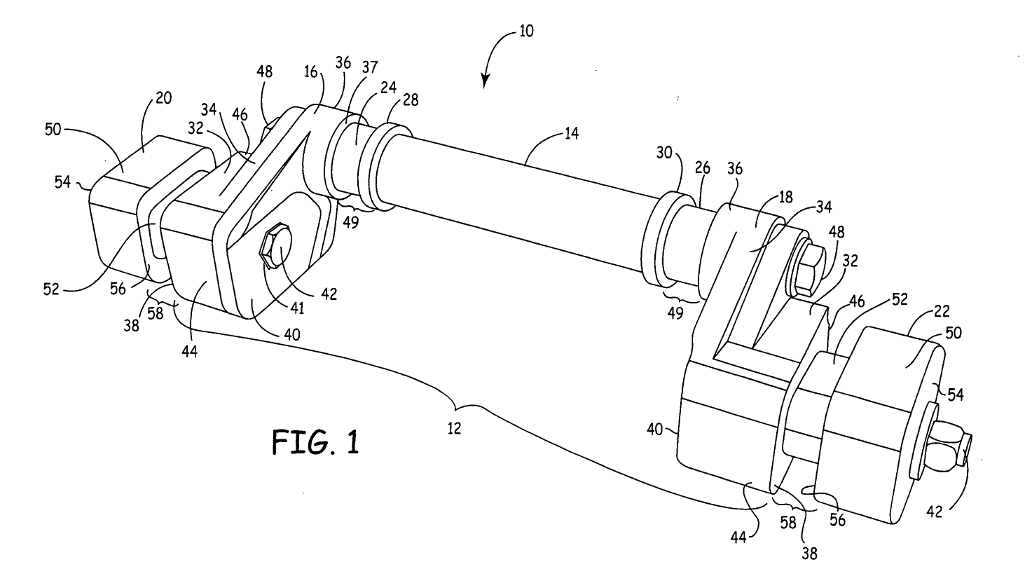

FIG. 1 shows an isometric view of one embodiment of the current invention. FIG. 1 shows an offset axle for a tracked vehicle, particularly a snowmobile. Offset axle 10 is comprised of inner body 12, first attachment member 20, and second attachment member 22. Inner body 12 is comprised of a shaft 14, a first connection member 16, and a second connection member 18.

Shaft 14 is a cylinder comprising a first end 24 and a second end 26. First end 24 and second end 26 of shaft 14 are machined to a smaller diameter than the central portion of the shaft 14, leaving a shoulder at each respective end 24 and 26. In one embodiment, the central portion is also machined to leave flanges 28 and 30 located proximate to each respective end 24 or 26. The diameter of the shaft 14 at each end 24 and 26 is nominally the same measurement as an inner mounting bearing on an idler wheel (not shown). The diameter of the flanges 28 and 30 are larger than the diameter of the ends 24 and 26 of shaft 14. The cylinder of shaft 14 contains threaded holes tapped into the faces of the cylinder at ends 24 and 26.

Shaft 14 is machined from a block of aluminum. In alternate embodiments, shaft 14 is fabricated from any rigid material, preferably a light weight metal such as tungsten. The lighter weight materials decrease the weight of the offset axle 10 and thus the overall weight of the tracked vehicle. Machining flanges 28 and 30 onto shaft 14 by removing material from the central portion of shaft 14 further decreases the weight of the vehicle. A lighter vehicle means that the standard engine is doing less work a propelling the machine and thus the machine can go faster.

The first end 24 of shaft 14 is connected to first connection member 16, while the second end 26 of shaft 14 is connected to the second connection member 18. In the embodiment illustrated in FIG. 1, second connection member 18 is a mirror of first connection member 16 about a plane that is perpendicular to the central axis of shaft 14. Connection members 16 and 18 are mounting blocks for securing the shaft 14 to the tracked vehicle.

In one embodiment, connection members 16 and 18 are machined from aluminum blocks. Both connection members 16 and 18 contain correlative structural features, including a main body portion 32, a bridging portion 34, and an shaft receptive extension 36. The main body portion 32 is generally shaped like a rectangular prism. Main body portion 32 contains a cavity that is a hollowed groove (not pictured in FIG. 1) machined near outer face 38. Main body portion 32 also contains an aperture for the reception of a fastener 42. The aperture runs perpendicular to inner face 40 and extends through main body portion 32 to the hollowed groove. In one embodiment, the aperture contains a countersink 41 on inner face 40 to provide a recessed area for the head of fastener 42. Fastener 42 is illustrated as a hex head bolt, but other fasteners are envisioned including pins, keys, latches, other threaded fasteners, or similar devices.

Bridge portion 34 is fabricated to be a general triangular shaped support from the front face 44 and back face 46 of main body portion 32, and radiates to extend past the intersection of front face 44 and back face 46. Bridging portion 34 connects main body portion 32 to an shaft receptive extension 36. Shaft receptive extension 36 is partially hollowed-out cylinder, much like a small capped section of a pipe, with a base terminating at or near the intersection with bridging portion 34. The inner diameter of the hollow portion is nominally the same as the outer diameter of shaft 14 at ends 24 and 26. The shaft receptive extension 36 is constructed to receive one end 24 or 26 of shaft 14. A hole is fabricated at the center of the base of shaft receptive extension 36 and extends through adjoining bridging portion 34.

First end 24 of shaft 14 connects to first connection member 16 by inserting first end 24 into shaft receptive extension 36. A threaded fastener 48 extends through the hole in bridging portion 34 and secures shaft 14 to first connection member 16 by tightening threaded fastener 48 into the threaded hole 64 tapped into first end 24 of shaft 14. Similarly, second connection member 18 connects to shaft 14 by placement of second end 26 of shaft 14 into shaft receptive extension 36 of second connection member 18 and securing both with another threaded fastener 48.

Assembling shaft 14 to connection members 16 and 18 completes inner body 12. Idler wheels (not illustrated) can be mounted on inner axle mount sections 49 located between flanges 28 and 30 and the outer face 37 of shaft receptive extensions 36 of connection members 16 and 18. Threaded fasteners 48 are used to secure shaft 14 to prevent the shaft 14 from rotating within the shaft receptive extensions 36 during operation of the tracked vehicle. Thus, idler wheels mounted to shaft 14 at inner axle mount sections 49 will be capable of independent rotation. Idler wheels typically are constructed with independent bearings so shaft 14 will not require bearings at ends 24 and 26 which increases the complexity of the offset axle construction. The use of fasteners 48 results in a semi-permanent structure which facilitates easy replacement of the various components of the offset axle 10.

First attachment member 20 attaches to first connection member 16, and second attachment member 22 attaches to second connection member 18. First attachment member 20 is a mirror of second attachment member 22 about a plane that is perpendicular to the central axis of shaft 14. Both attachment members 20 and 22 contain correlative structural features, and function as mounting blocks. In the embodiment illustrated in FIG. 1, attachment members 20 and 22 comprise a main body portion 50 and a connector 52, and are fabricated from the same material as connection members 16 and 18. Main body portion 50 is generally shaped as a parallelopiped. Main body portion 50 contains an aperture centrally located on an outer face 54. The aperture extends through both the main body portion 50 and the connector 52. The aperture allows for reception of fastener 42 to secure attachment members 20 and 22 to inner body 12.

In the embodiment shown in FIG. 1, the connectors 52 contain an outer profile that is an offset of the profile of main body portion 50. Also, connectors 52 extend from main body portions 50 of attachment members 20 and 22. Connectors 52 are shaped to have profiles nominally the same size of the hollowed groove of main body portion 32 of connection members 16 and 18. Connectors 52 are fabricated to obtain a depth that allows a rail mounting gap 58 between the outer faces 38 of connection members 16 and 18 and inner faces 56 of attachment members 20 and 22 while still extending into an adequate depth within connection members 16 and 18 to allow a structural mating of the two parts that can withstand the forces exerted upon the offset axle 10.

The offset axle 10 of this embodiment is referred to as a modified axle. In this embodiment, two inner idler wheels (not pictured) are mounted between the rails of the tracked vehicle to shaft 14 at inner mount axle sections 49. Idler wheels outside of the rails of the tracked vehicle are absent in this embodiment. This allows more flexibility in the outer edges of the track of the tracked vehicle. This flexibility in the track aids in turning the tracked vehicle in conditions of less packed snow, particularly for off-trail riding such as mountain riding, by allowing the machine to tilt to one side when a rider exerts force on the tracked vehicle. In a typical tracked vehicle, the shaft 14 is mounted to be aligned between the single fasteners 42. In the present invention, the biased mounting of shaft 14 with respect to the single fasteners 42 securing attachment members 20 and 22 and connecting members 16 and 18 allows for a larger diameter idler wheel to be placed within the preexisting track of the tracked vehicle. A larger diameter idler wheel results in less drag from the idler wheel, and thus results in an increase of speed for the vehicle.

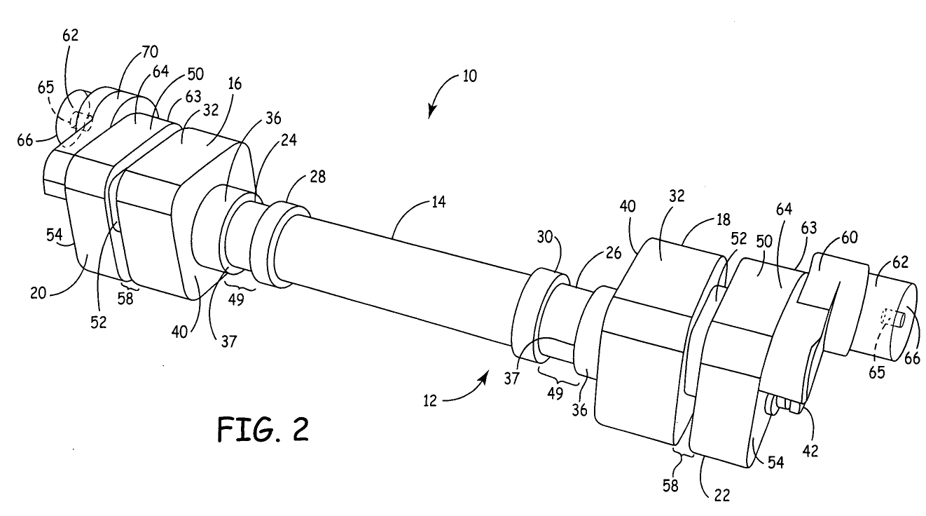

FIG. 2 illustrates another embodiment of the inventive rear offset axle. In this embodiment, idler wheels which are offset are located outside of the rails of a tracked vehicle rather than between the rails as in the embodiment of FIG. 1. The embodiment of FIG. 2 also is comprised of attachment members 20 and 22, and inner body 12 comprised of shaft 14 and connection members 16 and 18. In this embodiment, shaft 14 is structurally and compositionally equivalent to the embodiment of FIG. 1. Shaft 14 is a cylinder comprising a first end 24 and a second end 26, with flanges 28 and 30 located proximate to each respective end 24 or 26. The diameter of the flanges 28 and 30 is larger than the diameter of the shaft 14. In an alternate embodiment, shaft 14 is a cylinder with first end 24 and second end 26 machined to a smaller diameter than central portion leaving a shoulder proximate to each end. The smaller diameter of ends 24 and 26 provides inner axle mount sections 49 for mounting idler wheels. The cylinder of shaft 14 contains threaded holes tapped into the faces of the cylinder at ends 24 and 26.

First connection member 16 is a mirror of second connection member 18 about a plane that is perpendicular to the central axis of shaft 14. However, connection members 16 and 18 differ from those of FIG. 1. In the embodiment of FIG. 2, connection members 16 and 18 are generally rectangular prisms comprised of main body portions 32. No bridging portion is present in the current embodiment. Instead, the shaft receptive extension 36 is centrally located on the inner faces 40 of connection members 16 and 18. Shaft receptive extension 36 is fabricated to contain a channel for the reception of shaft 14. In an alternate embodiment, shaft receptive extension 36 is a section of round tubing attached to the inner face 40 of the main body portion 32. Idler wheels (not pictured) are mounted between the flanges 28 and 30 proximate to the ends 24 and 26 of shaft 14, and the outer faces 37 of shaft receptive extension 36 of connection members 16 and 18 at inner axle mount sections 49.

In the embodiment illustrated in FIG. 2, attachment members 20 and 22 comprise main body portions 50, connectors 52, bridging portions 60, and wheel mounts 62. First attachment member 20 is a mirror of second attachment member 22 about a plane that is perpendicular to the central axis of shaft 14. Connectors 52 and main body portions 50 of attachment members 20 and 22 correlate to the structure and composition of attachment members 20 and 22 in FIG. 1. In the embodiment of FIG. 2, attachment members 20 and 22 further comprise bridging portions 60 and wheel mounts 62 not present in the FIG. 1 embodiment.

Bridging portions 60 are constructed to attach wheel mounts 62 to main body portions 50 of attachment members 20 and 22. In one embodiment, bridging portion 60 is fabricated to be a generally triangular shape support. Each bridging portion 60 is attached to two adjoining faces 63 and 64 of the main body portion 50, and extends upward towards the front of the vehicle from the outer face 54 of the main body portion 50, and outward in the direction opposite of connector 52. This outward extension of bridging portion 60 allows for the installation of fastener 42 in a position which does not interfere with the rotation of the idler wheel attached to wheel mount 62.

The wheel mounts 62 are short cylindrical shafts extending from the bridging portions 60. The wheel mounts 62 are sized to allow the mounting of idler wheels (not pictured). Similar to the ends 24 and 26 of shaft 14, the wheel mounts 62 can be machined to leave a shoulder for idler wheels to mount against. The wheel mounts 62 contain a threaded hole 65 tapped into the outer face 66 of the wheel mount 62. This threaded hole 65 allows for reception of a fastener to secure an idler wheel to wheel mount 62.

Ends 24 and 26 of shaft 14 contain a threaded hole (not illustrated) tapped into the center of the outer faces of the ends 24 and 26. The treaded holes are concentric with the central axis of shaft 14. Connection members 16 and 18 each contain a hole centrally located within the base of shaft receptive extension 36 which extends through the entire connection member. Attachment members 20 and 22 contain an aperture that starts on the outer face 54 and extends through the main body portion 50 and connectors 52. The aperture is positioned so that when shaft 14 is placed between connection members 16 and 18, and attachment members 20 and 22 are mated with connection members 16 and 18, the apertures of the connection members 16 and 18 and attachment members 20 and 22 align with the threaded hole in shaft 14. Thus, a single fastener 42 can be used to secure all components together. Threaded holes in shaft 14 are sized to correspond to the threads of fastener 42, and extend into the shaft 14 from the outer surfaces of ends 24 and 26 to a depth that provides enough usable thread length to secure the components together under normal operating conditions.

In this embodiment, the idler wheels mounted on shaft 14 remain in a position that is typical of factory designed parts. That is, the idler wheels are mounted to an axle running between the two side rails wherein the axle is supported in line with the mounting components associated with the axle. Wheel mounts 62 are fixed in a bias position to allow larger diameter idler wheels to be mounted thereon compared to those mounted on shaft 14. For example, if a six and three-quarter inch wheel is to be placed on shaft 14 at inner axle mount sections 49, wheel mount 62 is positioned to allow an eight inch idler wheel within the same continuous track of the tracked vehicle. The difference desired in wheel diameters drives the shape and construction of bridging portion 60. In the embodiment illustrated, smaller factory idler wheels remain on the interior of the two rails, while larger diameter aftermarket wheels can be placed outside of the rails.

This embodiment is particularly useful for short-track vehicles. Short track vehicles contain a compacted suspension and drive system. Placing larger diameter idler wheels to the outer rear sides of the track of the vehicle assures that the larger idler wheels will neither interfere with the other components of the drive and suspension system nor will they interfere with the frame of the vehicle. If desired, smaller idler wheels are mounted at inner axle mount sections 49. The smaller diameter idler wheels are required in this position to assure the idler wheels mounted thereon do not interfere with the suspension and drive system. Short track vehicles include, but are not limited to, those with tracks of length of one hundred-twenty-one inches and one hundred-twenty-six inches.

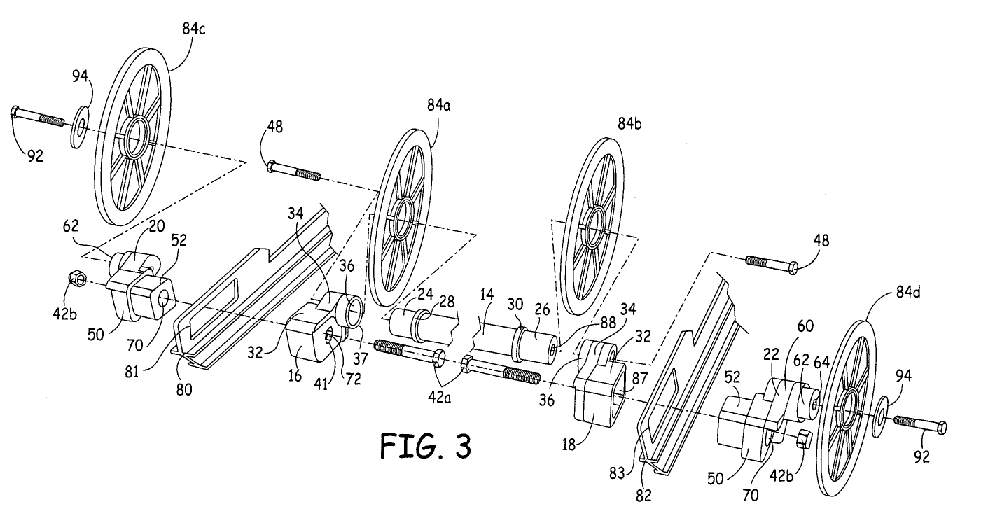

FIG. 3 is a assembly view of an offset axle 10 of the present invention. Like the embodiment of FIG. 2, up to four idler wheels can be mounted to the offset axle. However, all idler wheels, both those between the rails and those outside the rails of the tracked vehicle, are offset from the mounting position of the axle. In this embodiment, shaft 14 is structurally equivalent to the embodiments of FIGS. 1 and 2. Connection members 16 and 18 are structurally equivalent to those previously described in FIG. 1, and comprise main body portions 32, bridging portions 34, and shaft receptive extensions 36. Also, apertures 72 is shown through main body portion 32. Attachment members 20 and 22 are structurally equivalent to those previously described in FIG. 2. Attachment members 20 and 22 comprise main body portions 50, connectors 52, bridging portions 60, and wheel mounts 62. Apertures 70 through connectors 52 and main body portions 50, which have been previously described, are visible. Also illustrated in FIG. 3 are two parallel side rails 80 and 82 of a tracked vehicle. The side rails 80 and 82 contain preexisting openings 81 and 83. The invention of the offset axle 10 utilizes these preexisting openings 81 and 83 to secure offset axle 10 to the tracked vehicle.

In assembling the offset axle 10 onto a tracked vehicle, inner idler wheels 84a and 84b are placed on the shaft 14. Idler wheel 84a is placed on first end 24 of shaft 14 with the center resting against flange 28. Similarly, idler wheel 84b is placed on the second end 26 of the shaft 14 to a point where the center bearing of wheel 84b will be stopped by flange 30. After the wheels have been place on shaft 14, connection members 16 and 18 are attached to the shaft 14. The ends 24 and 26 of shaft 14 are inserted into the shaft receptive extensions 36 of connection members 16 and 18. The shaft 14 contains threaded openings 88 concentrically aligned with the central axis of shaft 14 at each respective end 24 and 26. A threaded fastener 48 is then used to secure the first connection member 16 to the shaft 14. Upon tightening of threaded fasteners 48 into threaded openings 88 of shaft 14, idler wheels 84a and 84b will be held in place by the flanges 28 and 30 of shaft 14 and by the outer face 37 of the shaft receptive extensions 36 of connection members 16 and 18. Once the inner body 12 comprised of shaft 14 and first and second connection members 16 and 18 is assembled, it is placed between the generally parallel preexisting openings 81 and 83 of side rails 80 and 82.

To secure the inner body 12 between side rails 80 and 82, attachment members 20 and 22 are attached to the inner body 12. In the embodiment shown in FIG. 3, attachment members 20 and 22 comprise main body portion 50, connector 52, bridging portion 60, and wheel mount 62 which correlate to the structures of the attachment members 20 and 22 of FIG. 2. Connectors 52 are sized to have a height nominally the same as the height of the preexisting openings 81 and 83 of the side rails 80 and 82. Connection members 16 and 18 each contain a hollow groove 87 extending into the main body portion 32. The hollow grooves 87 are sized to have nominally the same profile as that of the connector 52 of the attachment members 20 and 22. Attachment members 20 and 22 are placed so that the connectors 52 extend through the preexisting openings 81 and 83 of side rails 80 and 82 to mate with the hollow grooves of connection members 16 and 18.

Fasteners 42a-42b are used to secure the inner body 12 to the attachment members 20 and 22. In the embodiment shown in FIG. 3, the fasteners 42 are hex head bolts 42a inserted through the aperture 72 of the main body portions 32 of the connection members 16 and 18 and extend through the aperture 70 of the attachment members 20 and 22, and are secured with locking nuts 42b. In one embodiment, the main body portion 32 of connection members 16 and 18 contain a hexagonal countersink 41 for reception of a hex head bolt 42a. This aids in the installation of offset axle 10 by eliminating the need for a wrench on the head of hex head bolt 42a while tightening the fastener comprised of hex head bolt 42a and locking nut 42b.

After securing the inner body 12 with attachment members 20 and 22, additional idler wheels 84c and 84d are mounted to the wheel mounts 62. Idler wheels 84c and 84d are held in place on wheel mounts 62 by inserting a threaded fastener 92 into the threaded hole 64 of wheel mount 62. A washer 94 or similar structure is used to aid in securing the idler wheels 84c and 84d to wheel mounts 62. Once secured, idler wheels 84a-84d are concentrically aligned about an axis that extends through the center of wheel mounts 62 of attachment members 20 and 22. This axis extends through the center of shaft 14 to align the inner idler wheels 84a and 84b with the outer idler wheels 84c and 84d.

Although shown with four idler wheels 84, it should be noted that it is envisioned that a varying plurality of idler wheels 84 could be used with the current invention. For example, a person may wish to only install three wheels, leaving out one of the center idler wheels 84a or 84b, or may prefer to have only two outer idler wheels 84c and 84d. This embodiment is particularly useful for long track vehicles, for example, vehicles containing a one hundred-forty-one inch or greater length of track. The longer track vehicles contain a larger drive and suspension system, which alleviates some space concerns present in the short track vehicles.

In all embodiments, the shaft 14 is a solid, single piece with the ends 24 and 26 fabricated to allow for the mounting of idler wheels. The solid construction adds to the structural support which results in fewer failures due to the shaft 14 breaking during use of the tracked vehicle compared to a multi-piece unit. Further, less fabrication is required compared to a multi-piece unit. The present construction of shaft 14 also aids in assembly of the offset axle 10 by eliminating potential errors and time associated with assembling multi-piece constructions.

Another advantage present in all embodiments is the use of a single fastener 42 at each end to connect each of the connection members 16 and 18 to the corresponding attachment members 20 and 22. A single fastener requires less material to be removed for the aperture 70 of the attachment members 20 and 22 than a plurality of fasteners would require, which adds to the overall strength in the main body portions 50 and connectors 52. The offset axle 10 is also easier to install with a single fastener compared to a multiple fastener construction. A single fastener results in less interference with the idler wheel as only a single fastener needs to be located in the idler wheel windows to allow adjustment and securing of the fastener.

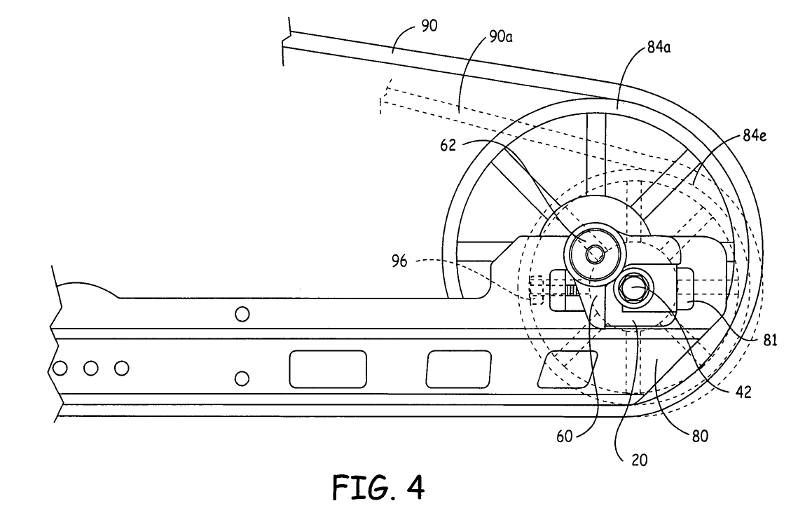

FIG. 4 depicts a side view of the rear of a tracked vehicle suspension and a track 90, including an idler wheel 84a mounted on the present inventive offset axle 10. The embodiment shown in FIG. 4 corresponds to the embodiment of FIG. 3. Shown in FIG. 4 is side rail 80 which contains preexisting opening 81, track 90, idler wheel 84a, wheel mount 62 of first attachment member 20, and fastener 42. In a typical tracked vehicle, an idler wheel 84e (shown in phantom) is centered around an axis at center of fastener 42. A track 90 is originally run around idler wheel 84e in the path indicated by 90a (shown in phantom). With the inventive axle, the idler wheels 84 are centered about an axis at the center of wheel mount 62. Wheel mount 62 is in a bias position from fastener 42. Bridging portion 60 of first attachment member 20 provides the bias which creates an offset from the typical tracked vehicle axle position. This offset allows for a larger diameter idler wheel 84a to place on the tracked vehicle without having to adjust the length of the preexisting track 90. A larger idler wheel 84c (not illustrated) could also be mounted to wheel mount 62 if desired.

A larger diameter means that there is more friction and momentum maintained by the idler wheels 84a. Thus, as a result a tracked vehicle will have better performance in that there will be an increase of speed absent a change in any other variables. The amount of offset will determine the increase in speed. For example, starting with an initial wheel of six and three-quarters inch or seven and one-quarter inch and going to an increased diameter of eight inches or eight and one-quarter inches can result in an increase in speed of between three to five miles per hour.

Also illustrated in FIG. 4 is set bolt 98. Although the height of the connectors 52 of attachment members 20 and 22 are nominally the same height as the preexisting openings 81 and 83 in side rails 80 and 82 (as shown in FIG. 3), the length of the preexisting opening may be greater than that width of the connectors 52. Thus, there is some adjustability in the mounting of the offset axle 10 to the side rails 80 and 82. Once the offset axle 10 is properly positioned, it is preferred that the offset axle 10 is locked in place. Set bolt 98 assures that the offset axle 10 of the present invention will not creep forward within preexisting opening 81 during operation of the vehicle. After installing the offset axle 10, set bolts 98 on the inner side of each respective side rail 80 and 82 are tightened to assure that the offset axle 10 does not move within preexisting openings 81 and 83 of the side rails 80 and 82 resulting in change in position, and thus possibly change in the tension of the track 90.

Although the present invention has been described with reference to preferred embodiments, workers skilled in the art will recognize that changes may be made in form and detail without departing from the spirit and scope of the invention.

1. An axle kit for a tracked vehicle having an endless track of a specific length, a suspension system, and two generally parallel rails attached to a suspension system containing a plurality of idler wheels attached to the parallel rails, wherein the axle kit allows for replacement of existing idler wheels with larger diameter idler wheels without a change of length of the endless track, the axle kit comprising:
a first attachment member;
a second attachment member;
a main body comprising:
a first connection member;
a second connection member;
a single machined axle connected to the first and second connection members.

2. The axle kit of claim 1 wherein the first attachment member and the second attachment member attach to opposite ends of the main body with a first and a second fastener, respectively,

3. The axle kit of claim 2 wherein the single machined axle comprises:
a first end fabricated to comprise a smaller diameter than an adjoining shoulder;
a second end fabricated to comprise a smaller diameter than an adjoining shoulder;
wherein the first end and second end contain threaded holes about a central axis of the single machined axle.

4. The axle kit of claim 3, wherein the single machined axle is mounted in a position offset from a position of the single fastener.

5. The axle kit of claim 4 wherein the first attached member and the second attachment member each further comprise a wheel mount containing a threaded hole concentrically aligned with a central axis of the single machined axle.

6. The axle kit of claim 3, wherein the first fastener attaching the first attachment member engages the threaded hole in the first end of the single member axle, and the second fastener attaching the second attachment member engages the threaded hole in the second end of the single machined axle.

7. The axle kit of claim 6 wherein the first attachment member and the second attachment member each further comprises a wheel mount in a position offset from a position of each respective single fastener.

8. For use in a tracked vehicle having a front drive axle, an endless track, a pair of substantially parallel rails spaced apart from one another, the pair defined by a first rail and a second rail with each rail having a rear end with an inner and outer side, a rear axle mountable to the rear ends of the first rail and second rail in the rear axle comprising:
a first mounting block for positioning adjacent the rear outer side of the first rail, the first mounting block comprising an extension with a single aperture;
a second mounting block for positioning adjacent the rear outer side of the second rail, the second outer block comprising an extension with a single aperture;
a first connection member comprising:
an aperture through the block, and a cavity partially through the block, wherein the cavity is sized to mate with the extension in the first mounting block; and
an shaft receptive extension containing a first channel;
a second connection member comprising:
an aperture through the block, and a cavity partially through the block, wherein the cavity is sized to mate with the extension in the second mounting block; and
an shaft receptive extension containing a second channel; and
a shaft containing a first end and a second end, wherein the first end mates with the channel of the shaft receptive extension of the first member, wherein the second end mates with the channel of the shaft receptive extension of the second member, and wherein the shaft is fabricated as a single body.

9. The axle of claim 8 wherein the shaft is concentrically aligned with the apertures of the first and second mounting blocks.

10. The axle of claim 9 wherein the first and second mounting blocks each are further comprising a mounting extension for an idler wheel offset from the axis of the shaft.

11. The axle of claim 8, wherein the extension of the first and second attachment members are offset from the single apertures.

12. The axle of claim 11, wherein the first and second mounting blocks each further comprise a mounting extension concentrically aligned with the extensions of the first and second attachment members.
